(19) United States
(12) Patent Application Publication
(10) Pub. No.: US 2010/0311385 A1
(43) Pub. Date: Dec. 9, 2010

(54) APPARATUS AND METHOD FOR GENERATING ALERTS

(76) Inventor: Larry Hurwitz, Alpine, UT (US)

Correspondence Address: Mark F. Wright;Wright Law Group, PLLC, Suite 103-376, 1959 South Power Road, Mesa, AR, 85206, US

(21) Appl. No.: 12/791,413

(22) Filed: Jun. 1, 2010

Related U.S. Application Data
(60) Provisional application No. 61/183,848, filed on Jun. 3, 2009.

(51) Int. Cl. H04M 11/04; H04W 4/00; G08B 21/00

(52) U.S. Cl. 455/404.1; 455/422.1; 340/665

(57) ABSTRACT

A system comprising a portable, hand-held device having an accelerometer controlled by a new protocol which acts to output accurate and rapid communication concerning one or more predetermined events to a monitoring service and to receive input communications through satellite communication and/or other communication means. In another embodiment, an installed device such as an AVL comprises communication means for short burst communication over satellite. The most preferred embodiments of the present system are also GSM and GPS enabled, thereby providing GSM and GPS positioning information that can be used in conjunction with the accelerometer data to monitor and detect predetermined events and, based upon the specific nature of the event, generate one or more alerts.

### CROSS REFERENCE TO RELATED APPLICATIONS

This non-provisional patent application claims the benefit of U.S. provisional patent application Ser. No. 61/183,848, which application was filed on Jun. 3, 2009, and which application is incorporated herein by reference.

### BACKGROUND OF THE INVENTION

1. Technical Field

This invention relates generally to the field of portable devices capable of wireless communication and more specifically relates to emergency communication signals actuable by the occurrence of an event in the vicinity of a portable device.

2. Background Art

In recent years, vehicles have been offered with onboard communication systems that can be user actuated or event actuated to notify a monitoring center. Generally, a user subscribes to a service and can communicate with that service by pushing a designated button in his or her vehicle. In addition, in the event of an accident, the monitoring center may be automatically notified so that it can send assistance, such as emergency response personnel. Because the vehicle can be located by global positioning technology (GPS) built into the onboard communications system, which can receive signals from a satellite that in turn is in contact with the monitoring center, the monitoring center can notify the emergency response personnel as to the location of the needed assistance.

Other users rely on cellular phones for emergency situations to provide the advantage of portability either in lieu of or in addition to the onboard communications system in their vehicle. However, cellular phone communication relies on cellular towers that could be absent from the location of emergency or compromised in function due to national disasters. In such cases, the cellular phones will not have service and cannot provide the needed communication. In addition, a cellular phone user needs to have a party to call to notify of the situation. If the location of the incident is such that there are no emergency service providers accessible by calling 911 or zero, or the recipient's service is not working, the cellular phone user cannot obtain the needed assistance. GPS capabilities added to cellular phones do not permit communication with the user seeking the assistance.

Despite the development of vehicle onboard technology and cellular phones, there is a continuing need for devices and methods that can assist users in the case of emergency situations that occur away from an installed onboard communications system.

### BRIEF SUMMARY OF THE INVENTION

A system comprising a portable, hand-held device having an accelerometer controlled by a new protocol which acts to output accurate and rapid communication concerning one or more predetermined events to a monitoring service and to receive input communications through satellite communication and/or other communication means. In another embodiment, an installed device such as an AVL comprises communication means for short burst communication over satellite. The most preferred embodiments of the system are also GSM and GPS enabled, thereby providing GSM and GPS positioning information that can be used in conjunction with the accelerometer data to monitor and detect predetermined events and, based upon the specific nature of the event, generate one or more alerts.

### BRIEF DESCRIPTION OF THE DRAWINGS

The various preferred embodiments of the present invention will hereinafter be described in conjunction with the appended drawings, wherein like designations denote like elements, and:

FIG. 1 is a schematic illustrating a system in accordance with a preferred exemplary embodiment of the present invention;

FIG. 2 is a schematic illustrating a system in accordance with a preferred exemplary embodiment of the present invention during an emergency response;

FIG. 3 is a schematic illustrating a system in accordance with an alternative preferred exemplary embodiment of the present invention;

FIG. 4 is a flow chart illustrating certain aspects of a system in accordance with a preferred exemplary embodiment of the present invention;

FIG. 5 is a flow chart illustrating certain aspects of a system in accordance with a preferred exemplary embodiment of the present invention;

FIG. 6 is a flow chart illustrating certain aspects of a system in accordance with a preferred exemplary embodiment of the present invention;

FIG. 7 is a flow chart illustrating certain aspects of a system in accordance with a preferred exemplary embodiment of the present invention;

FIG. 8 is a flow chart illustrating a system in accordance with a preferred exemplary embodiment of the present invention;

FIG. 9 is a flow chart illustrating the interaction of the device hardware of a system in accordance with a preferred exemplary embodiment of the invention;

FIG. 10 is a flow chart illustrating a GPS subroutine of a system in accordance with a preferred exemplary embodiment of the present invention;

FIG. 11 is a flow chart illustrating a controller programming of a system in accordance with a preferred exemplary embodiment of the present invention;

FIG. 12 is a flow chart illustrating a user input subroutine of a system in accordance with a preferred exemplary embodiment of the present invention;

FIG. 13 is a flow chart illustrating a measuring device subroutine of a system in accordance with a preferred exemplary embodiment of the present invention;

FIG. 14 is a flow chart illustrating an input device subroutine of a system in accordance with a preferred exemplary embodiment of the present invention;

FIG. 15 is a flow chart illustrating an output device subroutine of a system in accordance with a preferred exemplary embodiment of the present invention; and

FIG. 16 is a flow chart illustrating a method of detection of and reaction to an event using a system in accordance with a preferred exemplary embodiment of the present invention

### DETAILED DESCRIPTION

A portable, hand-held device comprising an accelerometer or a force or acceleration measuring device which is programmed to output accurate and rapid communications concerning predetermined and user-initiated events to a monitoring service through an established satellite communication or Global System for Mobile communication (GSM) system is disclosed. The device also can receive input communications through satellite communication or a GSM system. A “predetermined event” is defined herein as an occurrence that causes an output communication to be initiated from said device automatically. Such predetermined events are also referred to as Level 1 events. Further disclosed is an emergency alert system employing the portable hand held device and a monitoring service in communication therewith.

It is contemplated that the device and system of the invention will process Level 1 events in a different way from other events as explained below. A Level 1 event is defined as an event that has subjected the handheld device, and presumably the user thereof, to a g-force greater than or equal to a user specified quantity, for example 2 g. This level of force can generally be equated to a user event such as an accident which mayor may not have incapacitated the user of the device. A Level 2 event is defined as a user-initiated call of distress using manually actuated components, and a Level 3 event as a user-initiated call for information or request for services of a non-emergency nature.

The preferred force or acceleration-measuring device is an accelerometer. The accelerometer of the device is employed in the device as a part of the circuitry of the hand held device. Preferably, the accelerometer is a 3-axis type of accelerometer that can detect movement along the x-axis, the y-axis, and z-axis. The accelerometer is an electric device that monitors changes in acceleration or deceleration on the x-axis, the y-axis, or the z-axis. In the event of a change in acceleration, either positive or negative, a change in electric current, resistance, or voltage occurs. This change in electric current, resistance, or voltage is converted into a measurement of g-forces by the accelerometer itself or by a device or software associated with the accelerometer. In the present device, the microcontroller is set to monitor a set amount of g-forces provided to the portable hand held device that is indicative of a Level 1 incident. In a preferred embodiment, the microcontroller is set to trigger an automatic signal through a satellite or GSM network when a force of a user specified quantity, for example 2 9 or greater, is detected.

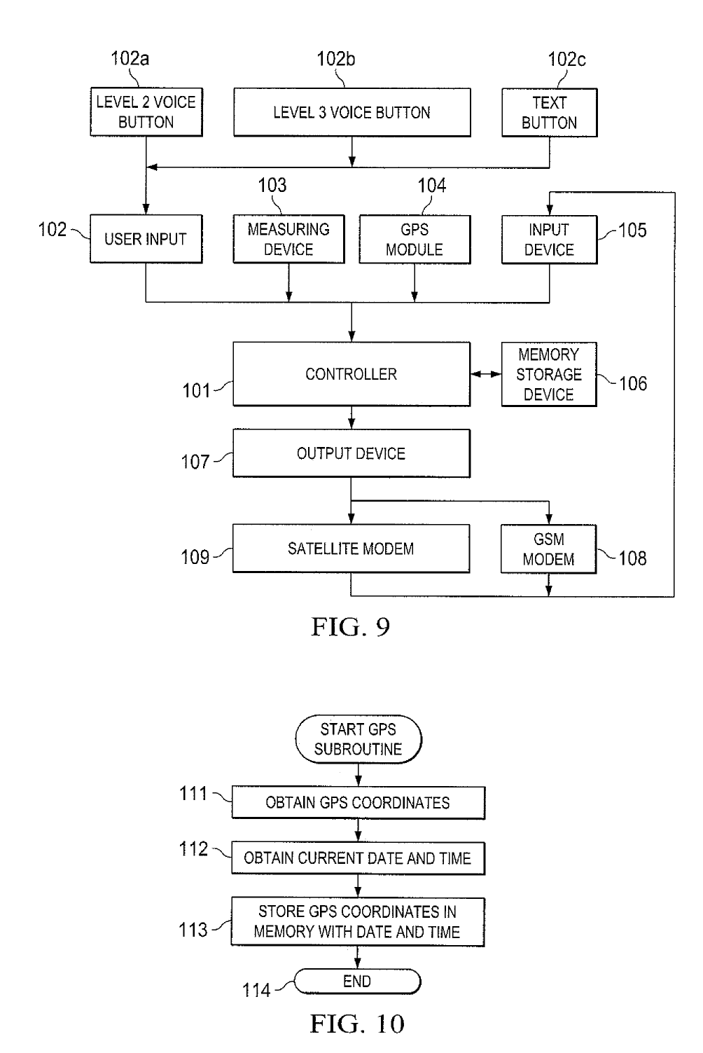

A preferred configuration within the handheld device for an exemplary accelerometer useful in the system of the invention is shown in FIG. 9.

In order to render the accelerometer useful in the invention, protocols for the operation of the handheld device are obtained from the manufacturer of the device. The protocol comprises a plurality of commands residing in the firmware or microcontroller of the handheld device that control the operation of the various features of the device. Each individual manufacturer of a device will generally have unique protocols specific to the device. The commands in the protocol that are relevant to the operation of the accelerometer of the device (accelerometer commands) are pre-identified by the manufacturer. The accelerometer commands residing in the manufacturer's protocol heretofore analyze the data or electronic signal generated by the accelerometer with the device responding, according to those protocols. Computers, phones and other electronic devices have included accelerometers for various purposes, but said components have been employed to protect the electronics or for the functionality of the electronics of the device.

The accelerometer commands are modified in accordance with the invention by insertion of a new accelerometer command or code which changes the operation of the microcontroller so that it releases a signal to a satellite or GSM (Global System for Mobile communication) modem in the device when a force of a user specified quantity, for example 2 g or greater, is detected.

The new accelerometer command is preferably communicated to the handheld device via the satellite modem or via a GSM communication mode if the handheld device is so equipped. It can also be communicated to the device by other methods known in the art. The new accelerometer command becomes part of the revised protocol of the phone. The new accelerometer command is written so that the microcontroller sends a signal to the satellite modem if the handheld device experiences a threshold force of a user specified quantity, for example 2 g or greater. A threshold force can be selected and programmed into the new accelerometer command according to requirements of the user.

In a most preferred embodiment, the portable device is customized to each individual user by changing the protocol as described above. By setting the sensitivity of the accelerometer to a custom level, the device provides a user with a custom incident g-force trigger point that will automatically report a Level 1 incident to the monitoring service.

Although the accelerometer sends signals to the microcontroller as a matter of course, according to the new accelerometer command, if the signal indicates that a predetermined force was exceeded, or that a button was user actuated, a signal will be sent from the microcontroller through a satellite or GSM modem of the device to indicate assistance is needed. The device further comprises a satellite and GSM modem that receives said signals from the microcontroller and communicates said signals to a satellite communications or GSM system. Providing the capability of satellite communication allows the device to operate independently of cellular towers that could be compromised by causes beyond the control of the user or non-existent in the area of needed response. The capability of satellite allows a user carrying said portable device to be monitored where no phone lines or cellular service exists, such as deserts, rural areas, mountains and other remote locations. The satellite can communicate with a monitoring center that has computers that transmit the signals received from the satellite into information recognized by the receiver. The satellite may communicate with other satellites that communicate with the monitoring center. The monitoring center computer can send communications over the Internet to an end user or other designee, as well as back to the portable hand held device.

Another preferred embodiment of the device may comprise an adapted Automatic Vehicle Location (AVL) system that comprises the needed hardware and a program interface, thereby providing the short burst satellite communication capabilities discussed below in connection with one or more portable hand held devices.

The most preferred embodiments of the system and method of the present invention allows voice files and multimedia files to be transmitted via a short burst satellite or GSM network. It is preferred that the portable device include a microphone which can receive continuous speech sound waves from a user and be saved as voice files in a memory located in the portable device.

To utilize the short burst network in accordance with a preferred embodiment of the invention, the handheld device useful in the system preferably further comprises a splitter program which can operate on voice files inputted into the handheld device by a user and split said voice files into smaller segments. The splitter program is adapted for use by the protocol of the device and is preferably downloaded onto the device by a user. It can also be placed onto the device by other methods known in the art.

The voice file segments, referred to herein as “voice filettes” will be separated by dead (no-sound) segments. These voice filettes can then be transmitted via a modem built into the portable device over a short burst satellite network to a receiving unit, usually located at the monitoring center. At the receiving unit, the voice filettes are recompiled by a computer programmed with software that is configured to recompile the voice filettes in the order received to form a reconstituted version of the continuous speech originally spoken into the portable device. The recompiled continuous speech can be saved in the computer and played back at a later time or played in sequence as they are received over the short burst satellite network by the receiving unit.

The present inventions allows for multimedia communications on a non-multimedia rationalized Satellite Network. Voice communications are accomplished utilizing a data channel of the satellite network and not the voice channel. This may be accomplished by converting the communication to be based upon a VoIP (Voice Over Internet Protocol) by dedicating a Uniform Resource Locator (URL) to the device pointing to a VoIP carrier. Software for VoIP is commercially available and an exemplary source is Skype™ (Luxembourg; San Jose, Calif.). The cost of voice communications is reduced as compared to the cost on a voice network, thus improving cost efficiencies by an estimated 8% to 50%. In the most preferred embodiments of the present invention, the portable hand held device also comprises the capability of transmission of multi-media files through satellite short burst communication.

The objective is to ensure that multimedia files are able to be transmitted between a satellite communication device, transmitted through a short burst satellite network, then received and then played by the receiving unit or base station. As voice communication in any form has not heretofore been possible on a short burst satellite network, due to the fact that the network band is not consistent, by transmitting voice in broken down parts and then replaying on the unit or base station of the other end and vice versa, now allows for voice to be transmitted over short burst satellite.

Multi-Media files are broken down, or segmented into acceptable Satellite Short Burst File sizes through available technology. The microprocessor component of the handheld device is programmed with a software algorithm that splits a multi-media file into segments.

The segmented multimedia files are referred to as multimedia “filettes” herein. The size of each multimedia filette is dependent upon the maximum allowed data file size by the Short Burst Satellite Network being used in this process. The multimedia filettes are transmitted during a Satellite Short Burst, as defined by the Satellite Network topology, to a receiving unit at the monitoring service or other designee.

The multimedia filettes can be either saved as sequenced incremental multimedia files or as independent multimedia files, depending upon the choice in how the receiving unit prefers to store or replay the multimedia file(s). The filettes are then transmitted during each Satellite Short Burst, as defined by the Satellite Network topology. Once the filettes are received by the receiving unit or monitoring service, the unit will either recompile the filettes based upon their sequencing order and then once complete, play the resulting multimedia file, or if each filette is a multimedia file format, play each filette as it is received. As a result, the segmenting into multimedia filettes provides the ability of the portable hand held device to transmit multi-media files over a short burst satellite network where it was not possible to be done in the past.

To accomplish the transmission of multi-media files, software is provided or uploaded onto a microprocessor in the portable hand held device. Upon input of the multi-media file into the device by the user or by a multimedia capturing functionality integral to the portable hand held device, the file is processed by the software and segmented if it is too large for transmission according to predetermined criteria. The segments are transmitted as data files over the satellite network to a receiving computer, usually located at the monitoring station and recompiled via software resident on the receiving computer.

A short burst data service is offered by Iridium, LLC (Bethesda, Md.) The Iridium® Short Burst Data (SBD) service enables the sending and receipt of SBD transactions of less than 2 KB in periodic time intervals efficiently. Short Burst communications are not continuous in contrast with cellular communication. While Iridium, LLC does provide a SBD service, the invention is not limited to only its services and the specific mention of the Iridium® serves only as an example short burst data service provider. Any short burst data service may be used in conjunction with the device.

The monitoring service preferably employs personnel who can respond to communications and/or houses one or more computers which store data concerning customers, translate signal data from satellites into communications recognized by a human or other computers, and can send communications to devices, other humans, or the user. In the context of this application, an exemplary monitoring service is referred to as “The SaaS Application.” Additionally, the various features and functions of the system may be accessed by the user and the administrator of the system via a web browser and the Internet. In the most preferred embodiments of the present invention, a Software As A Service (“SAAS”) application is provided for this functionality. By accessing the web-based SAAS application, the user can program various custom features and functions for the user's profile, thereby adapting the system for their specific needs and requirements. This allows for maximum flexibility of the system for multiple users.

The monitoring service both communicates out to the handheld unit via satellite and also receives communications from the handheld unit via satellite, providing the functionality of two-way communications via satellite.

In at least one preferred embodiment of the present invention, a portable hand held device comprises a satellite communicator component and a GSM (Global System for Mobile communication) communications component. GSM is generally most preferred simply because it is a digital mobile telephone system that is widely used in approximately 80 percent of the world or more. GSM uses a variation of Time Division Multiple Access (TDMA) and is the most widely used of the three digital wireless telephone technologies (TDMA, GSM, and CDMA). GSM digitizes and compresses data, then sends it down a channel with two other streams of user data, each in its own time slot. It operates at either the 900 MHz or 1,800 MHz frequency band. Although other digital wireless telephone technologies can also be used, they are not generally preferred.

The portable hand held device that includes satellite and GSM capabilities also preferably comprises a failover component. This function may be implemented by monitoring the strength of the GSM signal, which is supplied by the GSM service provider and changing from the GSM unit if and/or when the signal is not strong enough. The GSM service provider's infrastructure (base units) sends strength indicator information back to the hand held device, and the protocol of the handheld device generally provides a display of this strength indicator information to the user. This function is a common feature employed by handheld units employing GSM, such as ordinary cellular phones.

In the portable hand held device of the invention, once a weak GSM signal is detected (e.g., a signal that prevents the communication from being transmitted over the GSM Network) an enhanced protocol programmed into the device is activated and acts to shut down the GSM mode of the portable hand held device and to initiate communications through the satellite modem through a satellite network, such as Iridium®. This change of modes is also called “failover.” Failover functionality may be provided by using the satellite modem and an appropriate satellite network (e.g., Iridium®), thereby enhancing the robustness of the communication channel.

When the portable hand held device goes out of GSM Network range, users will still be able to communicate using the satellite network. The device may be programmed for automated failover from the GSM Network to Satellite Network in the event of GSM Failure or manual switch over from GSM Network to Satellite Network, at user's discretion.

The failover component consistently evaluates whether it is detecting receiving a GSM signal strong enough to communicate over the GSM network. This functionality is already employed in GSM-only devices with known technology. However, in the portable hand held device of the invention, once the failover component identifies that the GSM signal is not strong enough to continue to communicate; it will redirect communications through that satellite network. As a result, the user of the unit will have continues bi-directional communication between the unit and the monitoring service or other communication device.

The failover protocol is a computer program that is either preprogrammed into as firmware into the handheld device or uploaded or downloaded onto the handheld device. The portable handheld device is preferably programmable and able to receive external software protocols that enable increased functionality. Operating system software is generally provided as firmware by the phone manufacturer and updates may be periodically downloaded, as necessary and/or desired. Application software is generally available to portable handheld devices that are put in communicative relationship with monitoring centers that form a portion of the system according to the invention. Such application software may be uploaded to say portable handheld devices.

Preferably, the device further comprises an antenna that receives the modulated electrical energy from the modem and converts to an electromagnetic wave that can move through free space to a satellite. The antenna must be situated for line of sight communication. Line-of-sight is the direct propagation of radio waves between antennas that are visible to each other. Radio propagation modes at VHF and higher frequencies are generally needed. Communication between satellites and handsets is done using a TDMA and FDMA based system using L-band spectrum between 1616 and 1626.5 MHz. The type of modulation used is normally DE-QPSK although DE-BPSK is used on the uplink (mobile to satellite) for acquisition and synchronization.

The antenna is located in the portable hand held device as a separate feature or as part of the satellite modem. Preferably, the satellite system to which the voice signal moves is a Low Earth Orbit satellite system. A Low Earth Orbit system useful in connection with the invention is a system like that of the Iridium® system. (Iridium, LLC, Bethesda, Md.) Iridium Satellite LLC satellites use microwave rather than optical inter-satellite communications links allowing for various types of data to be relayed between satellites.

The portable hand held device also preferably includes the capability of bi-directional text messaging over a short burst satellite network. To date text messaging of information over a short burst has only been done in a single direction, from the unit in the field to a base station. In the present system and method, text communication over a short burst satellite network can be done by both the base station or another unit to the unit in the field, another unit in the filed or the base station, and then from the unit in the field to another unit in the field or the base station.

For example, Unit “A” in the field creates a text message, either being manually created by the user using the unit or automatically selected from a predefined series of text messages that have been programmed into Unit “A.” Unit “A” may then transmit one or more of the text messages to Unit “B” or to a base station over the short burst satellite network. Upon receipt, Unit “B” or the base station creates a reply, said reply comprising a manually created reply or one selected from a predefined series of text messages. Unit “B” transmits that reply back to Unit “A” back over the short burst satellite network. Thus creating a zigzag communication effect between Unit “A”, Unit “B” and/or the base Station, over the short burst satellite network.

As a result of this functionality, portable hand held units of the invention, when in the field, have the ability to have continuous bi-directional text messaging between multiple units in the field and/or the base station. In the most preferred embodiments of the present invention, the unit can also store text communication history.

The portable hand held unit will preferably assign specific predefined text messages to each of numbers on a digital phone keypad (e.g., when the user dials the number “1”, the number “1” has a predefined number and text message associated to it).

The portable hand held unit preferably can assign pre-determined numbers for each of the level incidences. Accordingly, when the user presses any of the unit's buttons, a predetermined or predefined text message may be sent to a specific number.

The most preferred embodiments of the present invention typically comprise portable hand held units comprising the functionality for transmission of human vital signs or health indicators (collectively “medical information”) via a short burst satellite network. A patient is able to have doctors and/or other emergency services monitor and/or be pre-alerted to personal medical emergency related incidents proactively relayed including location of that patient both prior and during a medical emergency.

In yet another preferred embodiment of the present invention, the portable hand held unit comprises a microprocessor or microcontroller that obtains this information and converts it to a transmittable signal which is inputted into a satellite modem in the portable hand held device. Baseline health values particular to the unit user—preferably are pre-programmed or uploaded into the microprocessor.

Medical information can be collected on a per incident basis or continuously. For example, paramedics responding to an emergency may take medical readings using various instruments and this information can be transmitted via the portable hand held unit of the patient or perhaps the paramedic to an emergency medicine physician who can provide instructions to the caregiver on sight based on the transmitted readings. The portable hand held unit may be equipped with a protocol for exchanging data over short distances from fixed and mobile devices such as Bluetooth® or the information may be transmitted from the medical instrumentation to the portable handheld device via a data cable connected to both devices. Alternatively, the medical instrument may comprise a portable satellite communication unit, and data may be transmitted from the medical instrument to the portable hand held device of the user via satellite. It is preferable that the communication relevant to the user's medical condition be communicated from his/her portable device to the monitoring service, because that device will be associated in the computers of the monitoring service with that user.

The profile and vital sign thresholds of the patients heart variance, and other vital sign variances to be monitored are preferably configured in the monitoring service system, which is then uploaded to the portable hand held unit. Once the any of the predefined Vital Sign Thresholds of the patient are broken, the unit starts sending off Level 1 incidences to the base station or other field unit. The information would include the GPS coordinates, the patient detail and continual vital sign data that can be recorded as it is received by the units.

The portable hand held device preferably comprises applications for geo-fencing. The device can transmit signals via satellite to a monitoring center that uses the information to monitor the boundaries of the user. Predefined messages can be transmitted to a person that needs to be contained in a particular area. Boundaries of countries can be made known to soldiers or other persons to avoid entering hostile territory. Other uses for geo-fencing include, mapping out the boundaries during transportation, such as a route a driver should take or the route a child takes going to school. Preferably, the application will fence and notify the user and/or monitoring station of any area that the unit will be traveling on.

The portable hand held device preferably comprises applications to locate the path the unit has traveled over almost limitless distances. The portable hand held device preferably comprises applications for providing navigation instructions to a user. Personnel at a monitoring station can communicate via satellite to the user providing live voice-guided driving directions to practically any destination.

The portable hand held device preferably comprises applications for providing stolen vehicle/unit location assistance. Real time GPS technology can be used to pinpoint the exact location of the device or a vehicle containing the advice.

The portable hand held device preferably comprises applications for seeking roadside assistance, information, concierge services, local weather reports, and other assistance as needed. The user can actuate a button that connects the user with the monitoring station that can send appropriate assistance to the exact location of the user or communications via satellite, which provide the requested information.

The portable hand held device preferably comprises applications for obtaining assistance during times of crisis. For example, during severe weather, natural disasters or other crisis, a monitoring center accessible through the portable hand held device satellite communication provides the user with a central point of contact to help the user navigate out of danger, and/or advise you of events that may be in harms way.

The portable device can be provided with convenient features that facilitate communication, for example outbound pre-set one button dialing, inbound cell communication that will allow practically anyone to call into the user.

The portable hand held device preferably comprises applications for unit Voice Monitoring to listen in on voice activity in the surroundings of the unit. In the most preferred embodiments of the present invention, the hand held device is a cellular telephone that has been programmed with an application that embodies the various functions and features described below.

In at least one preferred embodiment of the present invention, software is included in the system of the invention, residing in computers at the monitoring station. In addition, the original protocol of the hand held device is changed according to the system of the invention as described above so that the accelerometer provides an automatic distress signal as a result of predetermined values programmed into the new accelerometer protocol. Additional details will be explained in connection with the Figures appended hereto.

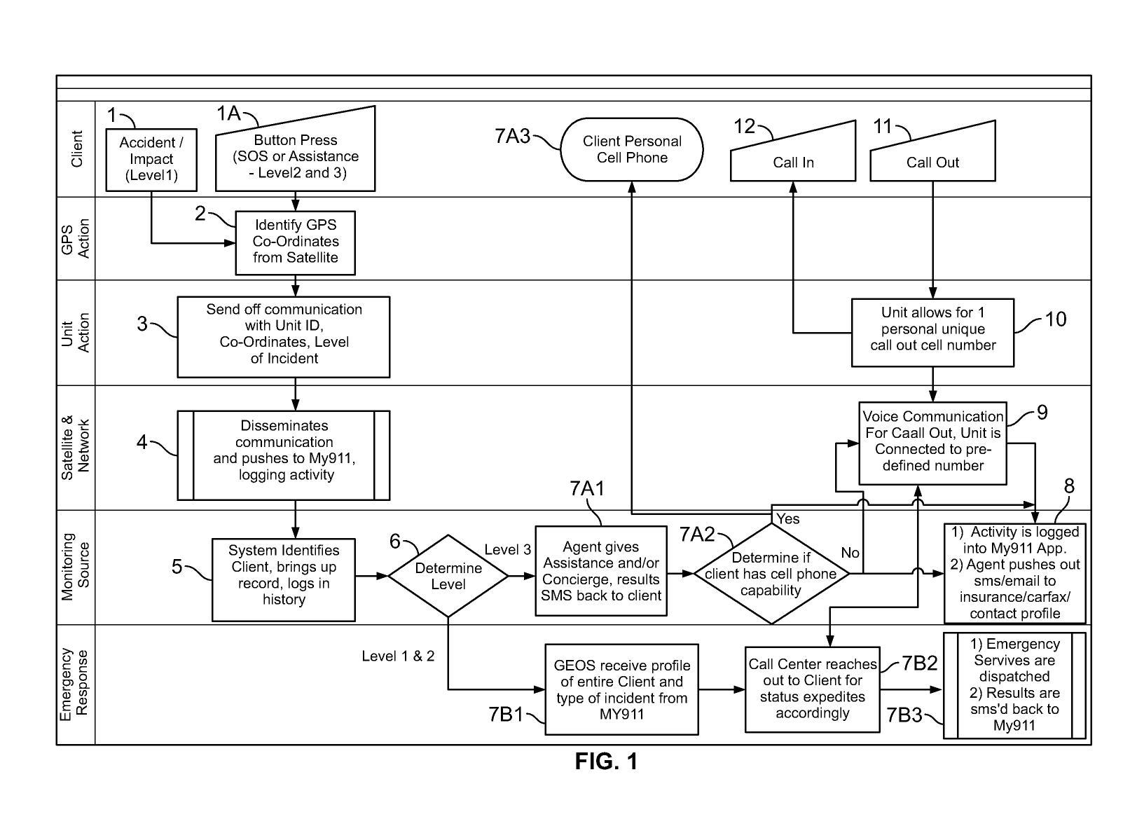

Referring now to FIG. 1, a schematic is provided which illustrates the actions of the portable hand held unit of the invention in an emergency response system. At Box (1) a Level 1 accident/impact occurs which generates an automatic signal. At Box (1A), a Level 2 or 3 request for assistance is initiated by the actuation of a button by a user. Both (1) and (1A) result in communication to a satellite or GSM from the unit which results in a responsive communication from the satellite containing the GPS coordinates of the unit to the unit. The unit then sends the GPS information, Level indication, Unit ID and any other information relevant to the incident inputted by the user or communicated to the unit locally to a satellite communications or GSM network (3) which communicates with a monitoring service that identifies the client, brings up the client record from its data base, and logs the activity (5), and from the Level data (6) progresses to (7A 1) for Level 3 or to (7B 1) for Level 1 or 2 incidents.

In at least one preferred embodiment of the present invention, level 3 requests for assistance are typically considered to be non-emergencies by definition, and the request can be further processed by determining if the client has a cellular phone capability (7 A2) and returning the requested assistance using that mode (7 A3) or if there is no cellular phone communications possible with the client at that time, further processing can take place through satellite communications or GSM through a predefined number (9) assigned to the unit. Either activity is logged at the monitoring center (8). For Level 1 & 2 requests, a communication is made at (7B 1) to an emergency response dispatcher or agency. A communication is made (782) to the user and further information is gathered if possible. The request is further handled at (783) by dispatching appropriate emergency personnel to the site of the incident. Reporting of all relevant information goes to the monitoring service at (8).

Still referring to FIG. 1, Box (10), the unit is assigned a personal number that can be dialed to reach the user (12). Alternatively, the user may wish to call out (11) from the unit or transmit voice filettes or media packets to another party or to the monitoring center (8) thorough satellite or GSM network (9).

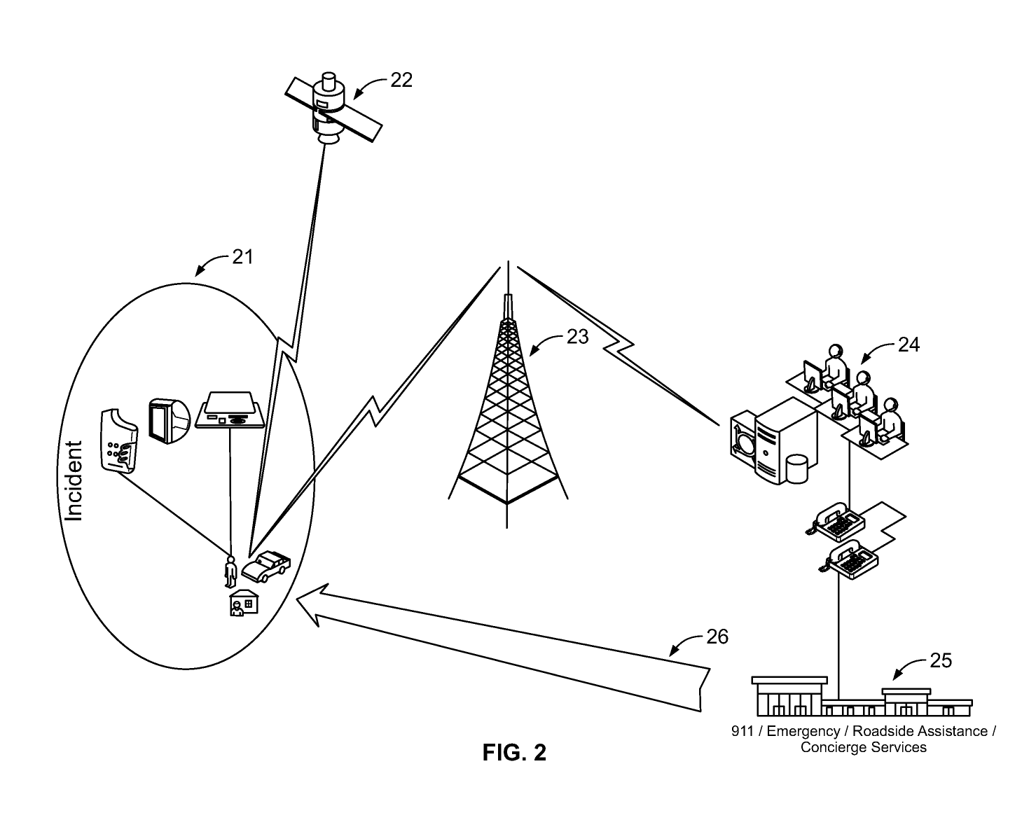

Referring now to FIG. 2, an example of the use of the portable hand held unit is depicted. At (21) an incident takes place involving a user of the portable hand held unit of the invention which automatically initiates an output communication, or alternatively, the user initiates a request for assistance. The portable hand held unit comprises an accelerometer that triggers an output communication as a result of accident because of excessive deceleration or acceleration resulting in the exceeded of the profiled g-force level. The portable handheld unit (exemplary units are shown in the forefront of the area labeled (21) in FIG. 2) preferably comprises a button that may be actuated by the user to manually request assistance.

Still referring to FIG. 2, at (22) a satellite communicates the GPS coordinates to the portable hand held device. GPS coordinates are determined by satellite-communication with the portable hand held unit on a continuous basis. The portable hand held unit communicates GPS coordinates (23) and other information generated by the portable hand held unit or inputted by the user to a satellite or tower (23) which in turn communicates to a monitoring service center (24) which houses computer systems with data previously submitted by the user and programs which can recognize and process the signals received, and communications devices. Further communications can take place from the monitoring service center to the user at the incident site (21) and to appropriate outside parties (25) who will be requested to provide assistance to the user at incident site (21).

Communications from the monitoring service center (24) to the user at the incident site (21) can be used to confirm the needs at the incident site if the effect of the incident on the user has left the user in a medical condition permitting him/her to communicate. The monitoring service center can use such communication to reassure the user and/or to gather further details to pass on to responders at (25). Any notified outside parties (25) would respond (26) to the incident scene (21) accordingly. Alternatively, the type of signal received can be used by the monitoring service to accelerate the response. An automatic triggering indicates a Level 1 response (e.g., that the user may have been in an accident that requires immediate response). User actuated requests (Level 2 or 3) may be triaged accordingly.

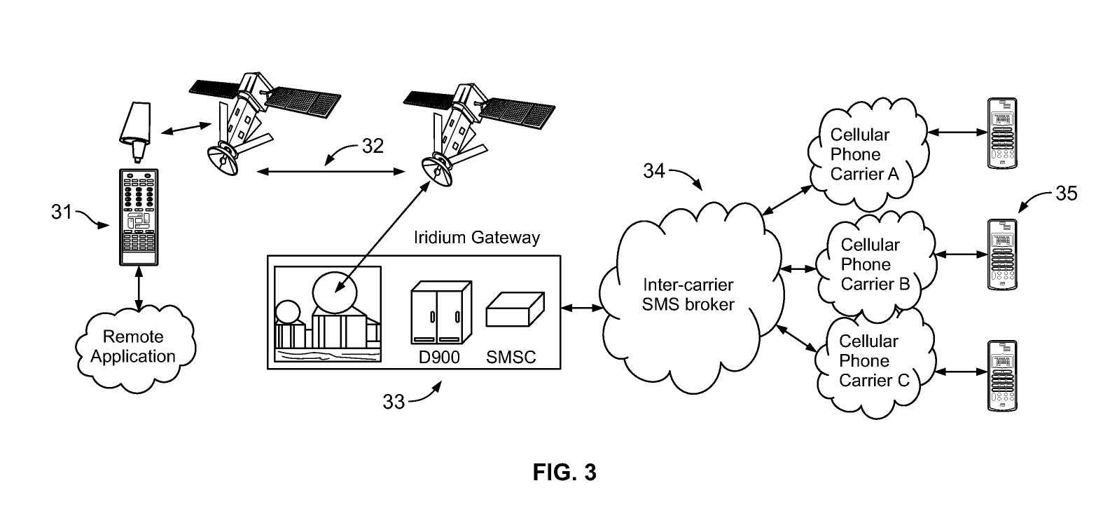

FIG. 3 depicts a preferred embodiment of the present invention in which the device (31) at the remote application bubble bi-directionally communicates with a satellite (32), which can communicate with other satellites to the monitoring station depicted in the central rectangle (33). Arrangements can be made with Short Message System (SMS) brokers (34) which facilitate two-way short message communications from various cellular phone carriers and customers (far right) (35).

Example 1 is a list of the preferred functions and features for a portable hand held unit and associated monitoring center used to deploy a system in accordance with at least one preferred embodiment of the present invention. It is anticipated that much of the data illustrated below will be input by the user of the portable hand-held unit by accessing the SaaS application via the Internet. Additional data and information may be input by the owner and/or operators of the SaaS website. Still more data may be generated automatically by the SaaS application over time and the user and the hand-held unit interact via the SaaS application. No limitation should be assumed by the lack of inclusion of any specific data element and/or functionality. Those skilled in the art will recognize that additional date elements and/or functions could be included without departing from the spirit and scope of the present invention.

### Example 1

### System Operational Specifications

### Primary Information and Functions

Each Unit has a unique ID;
Each Unit has a unique EMEI Number (The International Mobile Equipment Identity is a number unique to every GSM and UMTS and IDEN mobile phone as well as some satellite phones);
Each Unit has a unique Cell Number;
Each Contact has a unique ID
Each Client has a unique ID;
Each Client will always have at least one Contact associated to it Each Client can have unlimited number of contacts associated to it;
Each Client can have its own unique emergency dispatch associated to it;
Each Emergency Dispatch Center has its own:
   communication protocol;
   data format requirement; and
   hotline transfer phone number;
Each Contact will always have at least one Unit associated to it;
Each Contact can have unlimited number of Units associated with it;
Each Contact can have multiple secondary contacts (people to contact in the event of an emergency) information to include:
   Name;
   Relationship to User;
   Contact information (e.g., phone number, email, cell number); and
   Best or preferred contact mechanism.
Each Contact can profile themselves using the SAAS website with information including:
   Contact address;
   Medical profile;
   Primary Doctor and contact number;
   Medications being taken;
   Known Allergies;
   Medical Anomalies (Glasses, Pace Maker, Hearing Aid, Braces, Implants, etc.);
   If the portable device is to be used in conjunction with a vehicle:
      Vehicle Make, Model, Color and Registration Number;
      Whether there is a possibility of infant onboard;
   Insurance Medical Aid and P&C;
      Contact information;
      Insurance Policy Information;
   Roadside Assistance Company;
      Membership Number;

### Secondary Information and Functions

Each Unit can be contacted (e.g., “pinged”) from the SaaS Application;
Each Unit can be called from the SaaS Application using a Voice Over IP application (“VoIP”);
Each Unit can have silent barge-in activated from SaaS Application;
Each Unit can activate “engine kill switch” if unit is installed AVL (Automatic Vehicle Location) unit, from the SaaS Application;
Each Unit can activate one or more bread-crumb trail from SaaS Application;
Each Unit can have a predefined Geo-Fencing and Point of Interest (POI) established from the SaaS Application;
Each Unit can have predefined phone numbers assigned to unit keys established from the SaaS Application;
Each Unit can have a mini phone list uploaded established from the SaaS Application
Each Unit has x2 non-user controlled phone numbers assigned, controlled from SaaS Application at a system administration level:
Override Callout SOS Button (LeveI2), this calls directly into Emergency Dispatch
Assistance Button (LeveI3), this calls into The SaaS Application Assistance Help Desk (VoIP Phone System)
Each Unit has a factory-defined protocol controlled at a system administration level
Each Unit can maintain a history of all
   Incidents
   GPS attributes including speed points, altitude, bread-crumb trails
   IEEE and ANT Recorded information
   Each Unit has history of activities for a pre-defined period
      Agent Interface—Assistance Help Desk Agents support Level 3 Incidents
A software-based agent interface allows for links into YellowPages, White Pages, Google, etc.
Agent interface knows of incident unit location from GPS coordinates
Agent interface is capable of making outgoing VoIP calls
Agent interface is capable of communicating via SMS (text message) with unit and providing detailed information from YellowPage, White Pages or Google interface
Agent interface is capable of escalating incident to Level 2 incident Agent interface is capable of conferencing unit to 2^{nd} phone number Agent interface is capable of pinging unit for GPS location
Agent interface is capable of identifying status of multiple units and incidents in real time

### SaaS Application User View

A user of the The SaaS Application is controlled by user access rights assigned to them by The SaaS Application
A user can be made part of a group and access can be limited to only certain contacts within a client or clients
A user can select to view any or all of the units within their group
A user can select to view historical incidents and events within those incidents, map those incidents based upon the incident GPS coordinates at the time
A user can view bread-crumb trail over a pre-defined historical timeframe A user can view current bread-crumb trail of a unit
A user can ping any unit that is active and that they have access to view within their group
A user can edit all the contact and specific user definable unit information A user can define a Geo-Fence for a unit
A user can activate a Geo-Fence
A user can adjust the G-Force impact level signal threshold for triggering alerts
A user can run reporting for units, contacts and incidents within their group
A user can contact a unit in their group using VoIP or Text Messaging
A user can perform remote updates to a unit or multiple within their group with changes to various functional components within a unit
A user can export out specific data specific to their group

### SaaS Application Administration and Super Administrators Options

Administrators can perform all functions that of a SaaS Application User as well as the managerial and security functions of a system level administrator
Administrators may be limited to a predefined group of units (and related clients for those units)
Administrators can add users
Administrators can view and administer all clients, contacts and users within their designated group
Super Administrators can perform all functions that of an Administrator
Super Administrators can add new products and product profiles
Super Administrators have unlimited access and administration rights to the entire SaaS Application

### Incident Level Overview:

Level 1=Accident or Impact (pre-determined G-Forces threshold exceeded)
   Action
      Impact
      Notification of Impact through text message
      Emergency Center Calls Unit with known GPS Coordinates
      Appropriate action taken (e.g. dispatch of ambulance, calls to emergency contacts, etc.
Level 2=SOS (default option)
   Action
      Unit SOS Button pressed
      Notification of SOS through SMS text message
      Emergency Center Calls Unit with known GPS coordinates
      Appropriate action taken (e.g. dispatch of ambulance, calls to emergency contacts, etc.
Level 2=SOS (override option)
   Action
      Unit SOS Direct Call Button pressed
      Unit Calls Direct to Emergency Center
      Emergency Center Pings Unit for GPS coordinates
      Appropriate action taken (e.g. dispatch of ambulance, calls to emergency contacts, etc.

### Typical Processing of Incoming Incidents

Incoming Signal typically comprises 4 elements:
   1. Unique Unit Id
   2. GPS (coordinates)
   3. Level of incident (1, 2 or 3)
   4. Type of Connectivity (GSM or Satellite)
Signal comes through GPRS Modem attached the The SaaS Application Servers in the form of Text Message if the unit is on a GSM network
Signal comes through SMTP in Email format if using satellite communication mode
Signal is parsed into its 4 separate entities
System then queries main distributed unit database for exact match on Unit “Unique Id”
The Unit Unique ID is then associated with the contact and the contact with the client
A Query is then performed on all Primary Information specific to the:
Unit
Contact

### If Level 1 or Level 2 Incident

The information is formatted into a standard acceptable format as per the emergency response center requirements associated with to that client
The incident is logged into the history files specific to that having a unique emergency incident number
The incident is marked as “open”
The formatted information is then transmitted using the protocols agreed to by the SaaS application and the Emergency Dispatch Center
Once the Emergency Center accepts the transmission, the Emergency Center confirms receipt with a confirmation receipt specific to that unique emergency incident number
The SaaS software system then searches out that incident and marks that incident as “transferred” or “handed-off”

### In a GSM Communication Mode Scenario

The Emergency Dispatch Center reaches out to the unit via GSM communication and attempts to resolve the crisis

### In a Satellite Communication Mode Scenario

The Emergency Dispatch Center reaches out to the unit via Short Burst Satellite Voice Filette Communication and attempts to resolve the crisis
Once the Emergency Dispatch Center completes the crisis, a resulting file comprising of all actions taken by the Emergency Dispatch Center, using the same unique incident number generated initially by the SaaS Application in an acceptable format predefined by the SaaS Application and the Emergency Dispatch, is sent from the Emergency Dispatch Center to the SaaS Application using the communication protocols defined and accepted by both the SaaS Application and the Emergency Center
Upon receipt by the SaaS Application of the completed incident from the Emergency Dispatch Center, the SaaS Application searches for the unique incident number, updates the history file of that incident in the incident history file, and changes the incident from “handed-off” to “closed”

### If Level 3 Incident

### Request for Call-in Option:

The SaaS Application Level 3 agents module allows the agent to view the contact profile of the unit, the GPS coordinates of the contacts unit, various status of the unit, make VoIP calls to the unit, send text messages to the unit, ping the unit, activate a bread crumb trail, for certain AVL units, activate an engine kill switch if this has been installed in the vehicle, and launch 3^{rd} party web application like Yellow Pages, White Pages, etc.
The information is compiled and the unit IMEI number is identified from the compiled data
The system then pings the unit, requesting the units GPS coordinates using protocol supplied and required by the unit manufacture
The communication network medium used is determined by the 4^{th} Entity disclosure of the incoming signal. This being either GSM communication mode or Satellite communication mode
Once the GPS coordinates have been retrieved and associated with that unit, the system logs the GPS coordinates specific to that device in the system database
The GPS coordinates are then plotted on a geographic map, either Google map or other similar mapping utility, and presenting the units contact information
The SaaS Application Level 3 agent then makes an outbound VoIP call to the unit offering assistance
Depending upon the need of the contact, the agent is able to launch information type applications to assist the contact with their needs based upon their current GPS coordinates
The agent then has the option of advising the contact the information found, and/or text messaging and/or emailing the information from the agent console to the contacts unit or other cell device
Each communication is logged into the history file for that specific unit
Each incident is left open until the communication is signed off by the Assistant Agent as complete

### GSM Unit Call-in Option:

This option is only available if the unit is in GSM Network coverage
The contact presses the assigned “Assistance Button” on their unit
The unit connects through the data channel or voice channel depending upon the GSM network carrier being used
The call from the unit comes into the SaaS Application Virtual PBX
The PBX unit identifies an available the SaaS Application agent, and routes the call to that agent
The system searches out the unit based upon the unique phone number of the unit as per the caller-id component of the PBX
The information is compiled and the unit IMEI number is identified from the compiled data
The system then pings the unit, requesting the units GPS coordinates using protocol supported and required by the unit manufacturer
The communication network medium used is determined by the 4^{th} Entity disclosure of the incoming signal. This being either GSM or Satellite
Once the GPS coordinates have been retrieved and associated with that unit, the system logs the GPS coordinates specific to that device in the system database
The GPS coordinates are then plotted on a geographic map, either Google map or other similar mapping utility, and presenting the units contact information
The SaaS Application agent then commences with the assistance call
Depending upon the need of the contact, the agent is able to launch information type application's to assist the contact with their needs based upon their current GPS coordinates
The agent then has the option of advising the contact the information found, and/or text messaging and/or emailing the information from the agent console to the contacts unit or other cell device
Each communication is logged into the history file for that specific unit
Each incident is left open until the communication is signed off by the Assistant Agent as complete

### Level 3 Satellite Unit Bi-Directional Text Message Option:

This option is available with Satellite Modem Mounted units only
The contact presses the assigned “Assistance Button” on their unit
Other buttons are assigned specific assistance messages (Roadside Assistance Needed, Towing Assistance Needed, Report an Accident
The unit identifies, through the operating system, that it has a satellite connection
The unit enquires its GPS coordinates through its GPS modem
The unit sends off a pre-defined text message along with the 4 entities over the satellite network to a predefined text message incoming bin address, located in the SaaS Application
The SaaS Application sweeps the incoming bin for all new text messages
The new messages are then distributed to various SaaS Application Assistant Agents assigned to handle bi-directional text messaging
The information is compiled and the unit IMEI number is identified from the compiled data
The The SaaS Application system logs the GPS coordinates specific to that device in the system database
The GPS coordinates are then plotted on a geographic map, either Google map or other similar mapping utility, and presenting the units contact information
The The SaaS Application Assistant agent replies back to the unit requesting or advising contact of information
Each communication is logged into the history file for that specific unit
Each incident is left open until the communication is signed off by the Assistant Agent as complete

### Level 3 Satellite Unit Bi-Directional Voice Filette Message Option:

This option is available with Satellite Modem Mounted units only
The contact presses the assigned “Voice Record Button” on their unit, and records their message
The solution on the unit splices the voice file into filettes small enough to be sent over short burst satellite
The unit identifies, through the operating system, that it has a satellite connection
The unit enquires its GPS coordinates through its GPS modem
The unit sends off a pre-defined text message along with the 4 entities over the satellite network to a predefined text message incoming bin address, located in the SaaS Application, followed multiple transmissions of the filettes, until all filettes are been transmitted from the unit to the incoming bin
The SaaS Application sweeps the incoming bin for all new text messages
The new messages are then distributed to various the SaaS Application Assistant Agents assigned to handle bi-directional voice messaging
The information is compiled and the unit IMEI number is identified from the compiled data
The SaaS Application system logs the GPS coordinates specific to that device in the system database
The GPS coordinates are then plotted on a geographic map, either Google map or other similar mapping utility, and presenting the units contact information
The SaaS Application Assistant agent plays the filettes in sequence
The SaaS Application Assistant agent replies back to the unit by recording and splicing the voice file into filettes, and then sending the filettes back to the unit over the short burst satellite network
The unit upon receiving the filettes plays back the sound files in order of sequence
Each communication is logged into the history file for that specific unit
Each incident is left open until the communication is signed off by the SaaS Application Assistant Agent as complete.

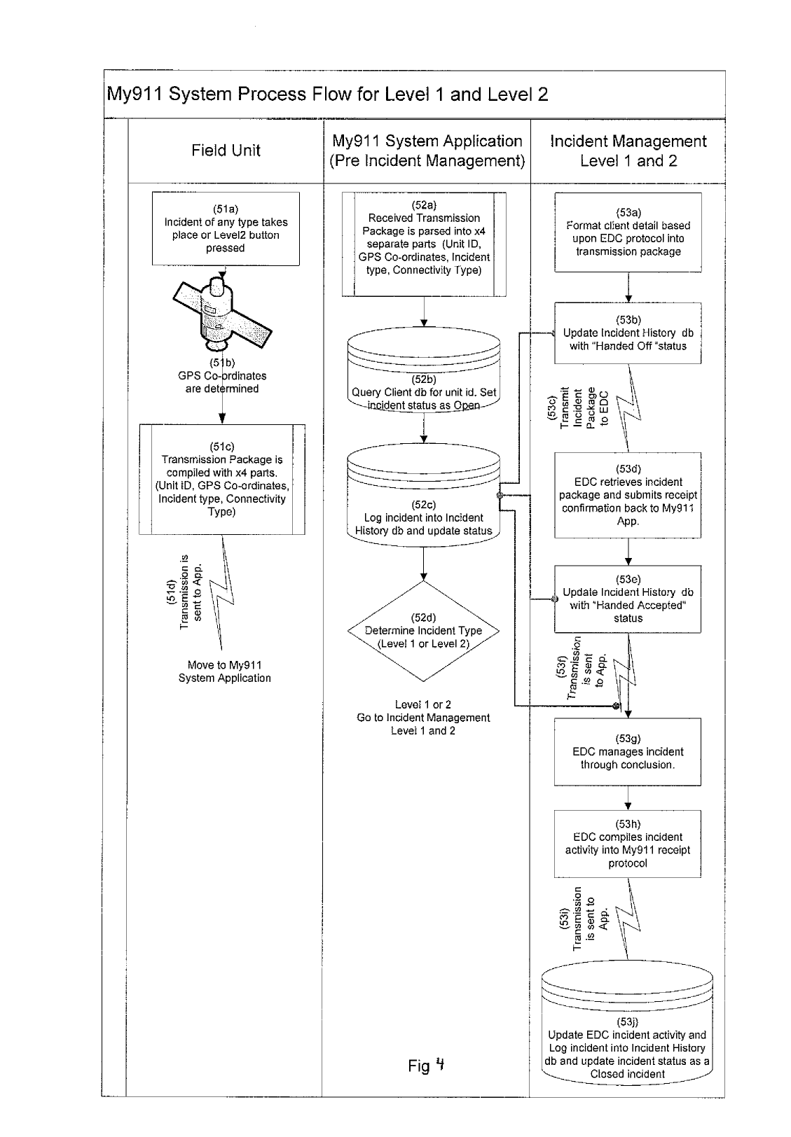

Referring now to FIG. 4, a flow chart showing an example of the system process for The SaaS Application for a Level 1 or 2 incident. Box (51a) represents the activation of the device by automatic means triggered by sensing an exceeded user specified g-force or by manual means triggered by actuation of a button. When activation occurs, GPS coordinates of the device location are obtained from a GPS satellite (51b). A transmission package is compiled (51c) with four parts: unit ID, GPS coordinates, incident type, and connectivity type where it is then sent to The SaaS Application system application (51d). The received transmission is parsed into its four separate parts (52a). Client database is queried for unit ID and incident status is set to open (52b). The incident is logged into an incident history database and status is updated (52c). It is then determined whether incident is Level 1 or 2 (52d). The client detail is then formatted based upon EDC (Emergency Dispatch Center) protocol into a transmission package (53a) with the incident history database updated to a “handed off” status (53b). After the incident package is sent to the EDC (53c), the EDC submits receipt confirmation back to the SaaS Application system application (53d) and the incident history database is updated to “handed accepted” status (53e). Transmission of the update is sent to System Application (53f). EDC manages the incident through the conclusion (53g) and compiles an incident activity into the SaaS Application receipt protocol (53h). The incident activity is sent to the SaaS Application system application (53i) and the incident history database is updated with the EDC incident activity and log incident and incident status is updated as a closed incident (53j).

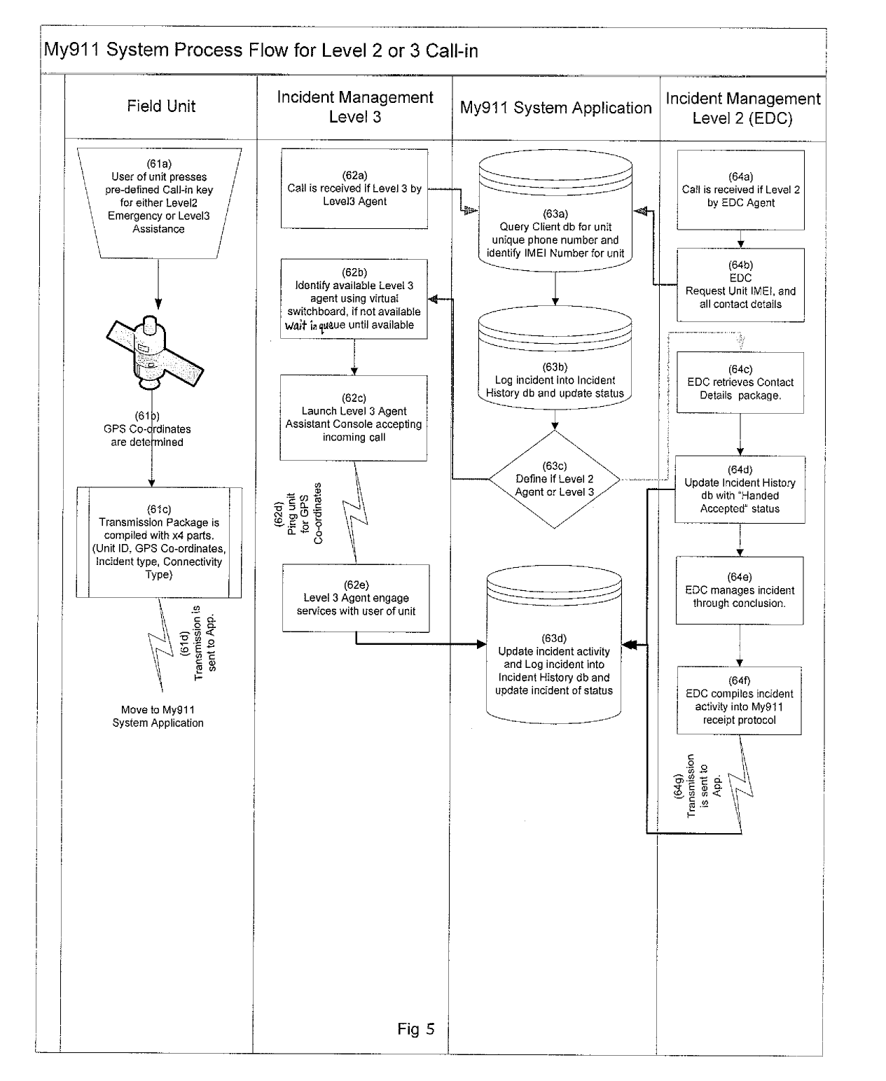

Referring now to FIG. 5, a flow chart showing an example of the system process for the SaaS Application for a Level 2 or 3 call-in. The user (e.g., “contact” or person using the unit) first activates the device by actuation of the Level 2 or Level 3 call-in button (61a). When activation occurs, the GPS coordinates of the device location are obtained from one or more GPS satellites (61b). A transmission package is compiled (61c) with at least four parts: unit ID, GPS coordinates, incident type, and connectivity type where it is then sent to the SaaS Application system application (61d). The call is received by a Level 3 Agent (62a) or an EDC (Emergency Dispatch Center) Agent (64a) requiring contact details (64b) who query client database for unit unique phone number and identity IMEI (International Mobile Equipment Identity) number for unit (63a). The incident is logged into an incident history database and status is updated (63b). Incident is defined as Level 2 or 3 and information is sent to the Incident Management of the relating Level (63c). If sent to the Incident Management for Level 3, a search for an available Level 3 agent is performed using a virtual switchboard (62b). Incident will wait in queue for an available agent if none is primarily found. The Level 3 agent will launch a Level 3 Agent Assistant Console to accept the incoming call (62c) and ping the unit for GPS coordinates (62d). The Level 3 agent will engage services with user of unit (62e) and update any incident activity (63d). If information from (63c) is sent to Incident Management for Level 2, the EDC retrieves

the Contact Details package (64c). Incident activity is logged into the incident history database (63d) and is updated to “handed accepted” status (64d). EOC manages the incident through the conclusion (64e) and compiles an incident activity into the SaaS Application receipt protocol (64f). The incident activity is sent to the SaaS Application system application (64g) and the incident history database is updated with the EDC incident activity and log incident (63d).

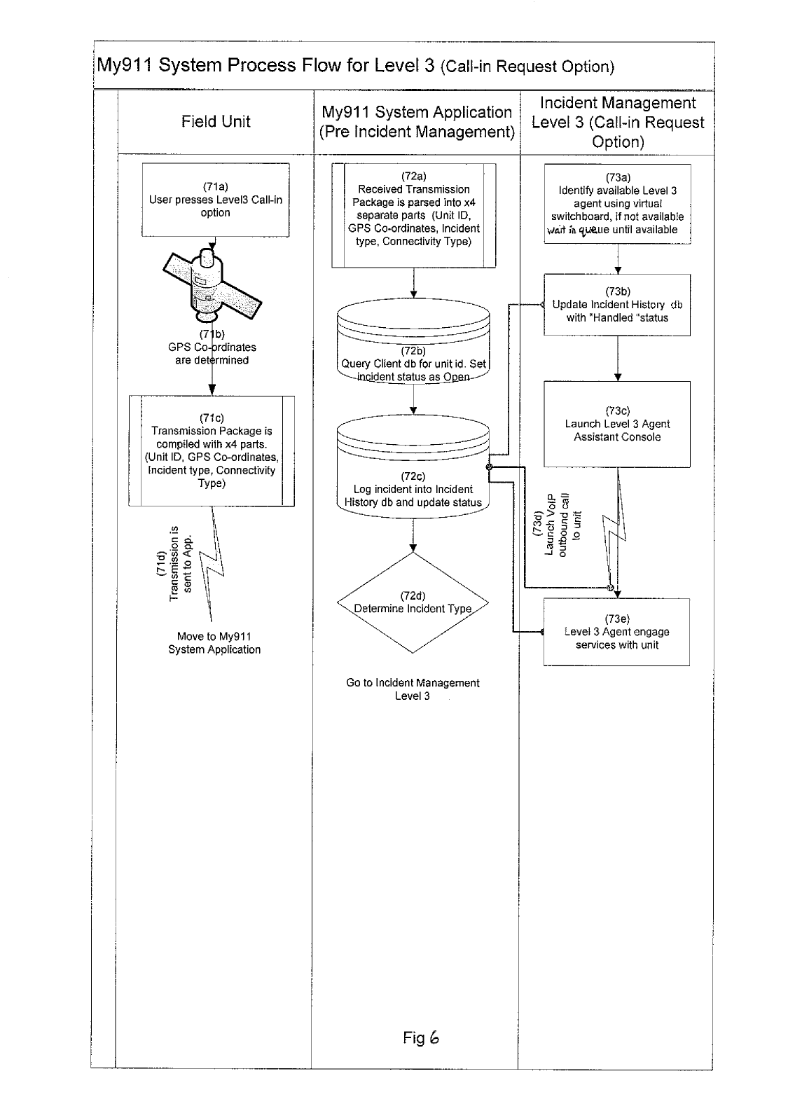

Referring now to FIG. 6, a flow chart showing an example of the system process for the SaaS Application for a Level 3 incident. The user first activates the device by actuation of the Level 3 call-in or voice button (71a). When activation occurs, GPS coordinates of the device location are obtained from a GPS satellite (71b). A transmission package is compiled (7ic) with four parts: unit 10, GPS coordinates, incident type, and connectivity type where it is then sent to My9i1 system application (71d). The received transmission is parsed into its four separate parts (72a). Client database is queried for unit ID and incident status is set to open (72b). The incident is logged into an incident history database and status is updated (72c). The type of incident is then determined (72d). Identification of an available Level 3 agent is done using a virtual switchboard (73a) and if one is not available, wait in queue until an agent is available. The incident history database is updated to a “handled” status (73b). The Level 3 agent assistant console is initiated (73c), and a VoIP outbound call is made to the unit or device (73d). The Level 3 agent then engages services with unit. (73e).

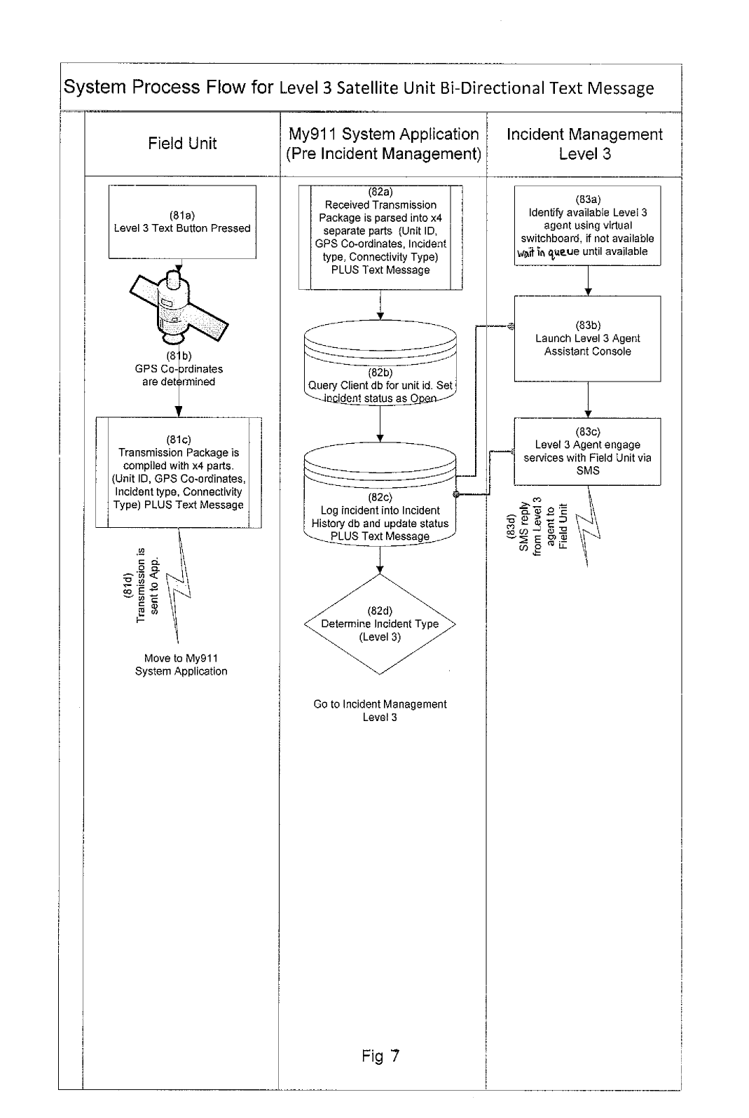

Referring now to FIG. 7, a flow chart showing an example of the system process for The SaaS Application for a Level 3 satellite unit bi-directional text message. The user first activates the device by actuation of the Level 3 text button (81a). When activation occurs, GPS coordinates of the device location are obtained from a GPS satellite (81b). A transmission package is compiled (81c) with four parts: unit ID, GPS coordinates, incident type, and connectivity type along with a text message where it is then sent to The SaaS Application system application (81d). The received transmission is parsed into its four separate parts along with the text message (82a). Client database is queried for unit ID and incident status is set to open (82b). The incident is logged into an incident history database and status and text message are updated (82c). The type of incident is then determined (82d). Identification of an available Level 3 agent is done using a virtual switchboard (83a) and if one is not available, wait in queue until an agent is available. The Level 3 agent assistant console is initiated (83b), where a Level 3 agent engages services with field unit via SMS (Short Message System) (83c) and sends a SMS reply to the field unit (83d).

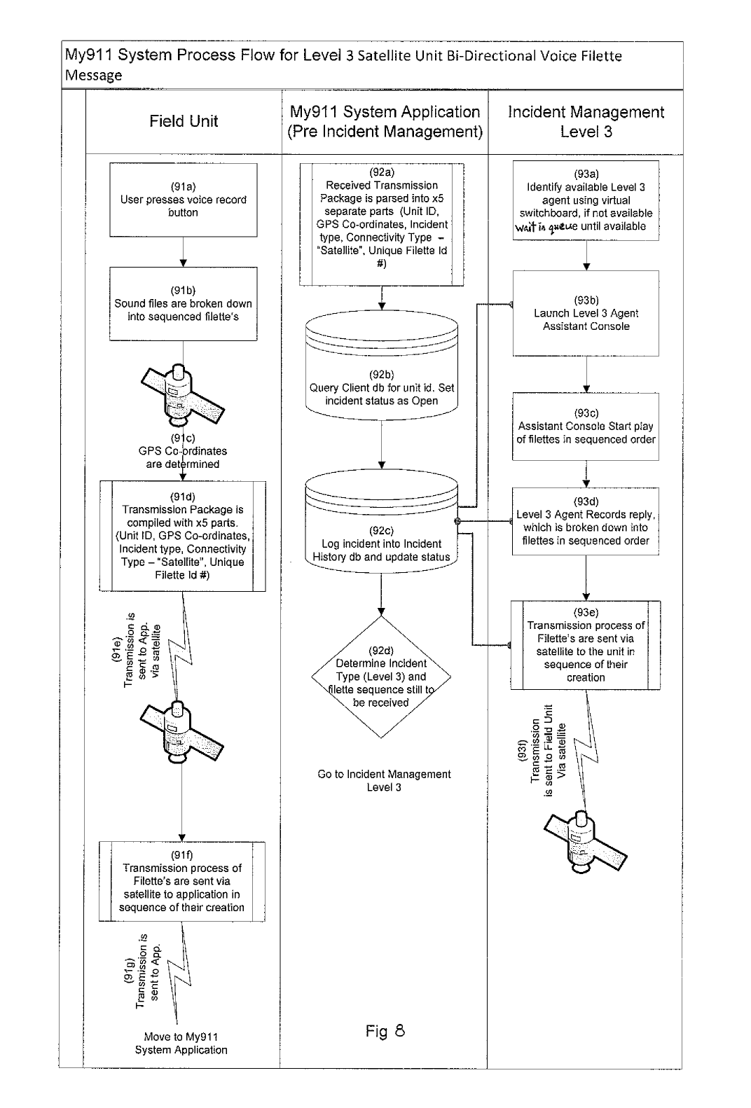

Referring now to FIG. 8, a flow chart showing an example of the system process for The SaaS Application for a Level 3 satellite unit bi-directional text message. The user first activates the device by actuation of the Level 3 voice record button (91a). The recorded sound files are broken down into sequenced filettes (91b). GPS coordinates of the device location are obtained from a GPS satellite (91c). A transmission package is compiled (91d) with five parts: unit ID, GPS coordinates, incident type, connectivity type—“satellite”, and unique filette ID number. Transmission package and filettes are sent to The SaaS Application system application via satellite in sequence of their creation (91e). The received transmission is parsed into its five separate parts (92a). Client database is queried for unit ID and incident status is set to open (92b). The incident is logged into an incident history database and status is updated (92c). The type of incident is then determined (92d). Identification of an available Level 3 agent is done using a virtual switchboard (93a) and if one is not available, wait in queue until an agent is available. The Level 3 agent assistant console is initiated (93b) and the assistant console begins to play the filettes in sequenced order (93c). The Level 3 agent then records a reply which is broken down into filettes in sequenced order (93d) and transmitted via satellite to the unit in sequence of their creation (93e).

Referring now to FIG. 9, the controller (101), or microcontroller, receives inputs or information from various input devices, for example, user input device (102), a measuring device (103), a GPS module (104), or input device (105). The controller (101) is also linked to a memory storage device (106) which allows for data storing or data retrieval. Data is collected and processed through the controller (101) and depending on parameters set, sends information to the output device (107) to be delivered to an external source. These external sources are the GSM modem (108) or satellite modem (109). The GSM (108) and satellite (109) modems also receive the information collected by the Input Device (105). Various alert buttons feed into the User Input device (102), for example Level 2 Voice Button (102a), Level 3 Voice Button (102b), and a Text Button (102c).

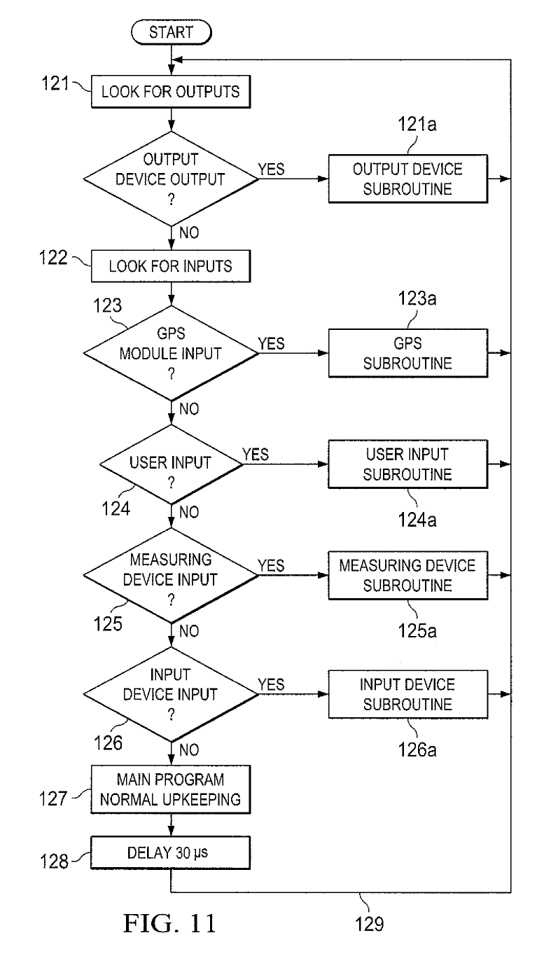

Referring now to FIG. 11, also known as the main program, once the unit or device is initialized, the controller (121) looks for any data ready to be sent to the Output Device. If output data is found, the Output Device subroutine (121a) is initiated. If output data is not found, the controller begins to look for any input data being received (122) from the input devices. The controller first looks for input data from the GPS Module (123). If input data found, the GPS subroutine (123a) is initiated. If no input data found, controller looks for input data from the User Input (124). If input data found, the User Input subroutine (124a) is initiated. If no input data found, controller looks for input data from the Measuring Device (125). If input data found, the Measuring Device subroutine (125a) is initiated. If no input data found, controller looks for input data from the Input Device (126).lf input data found, the Input Device subroutine (126a) is initiated. If no input data found, controller performs main program normal upkeeping (127) and then waits a predetermined time (128), for example 30 microseconds, before looking for output data once again (129).

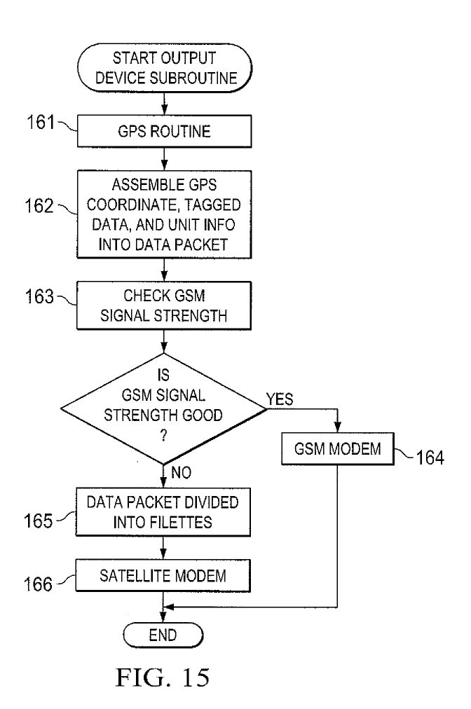

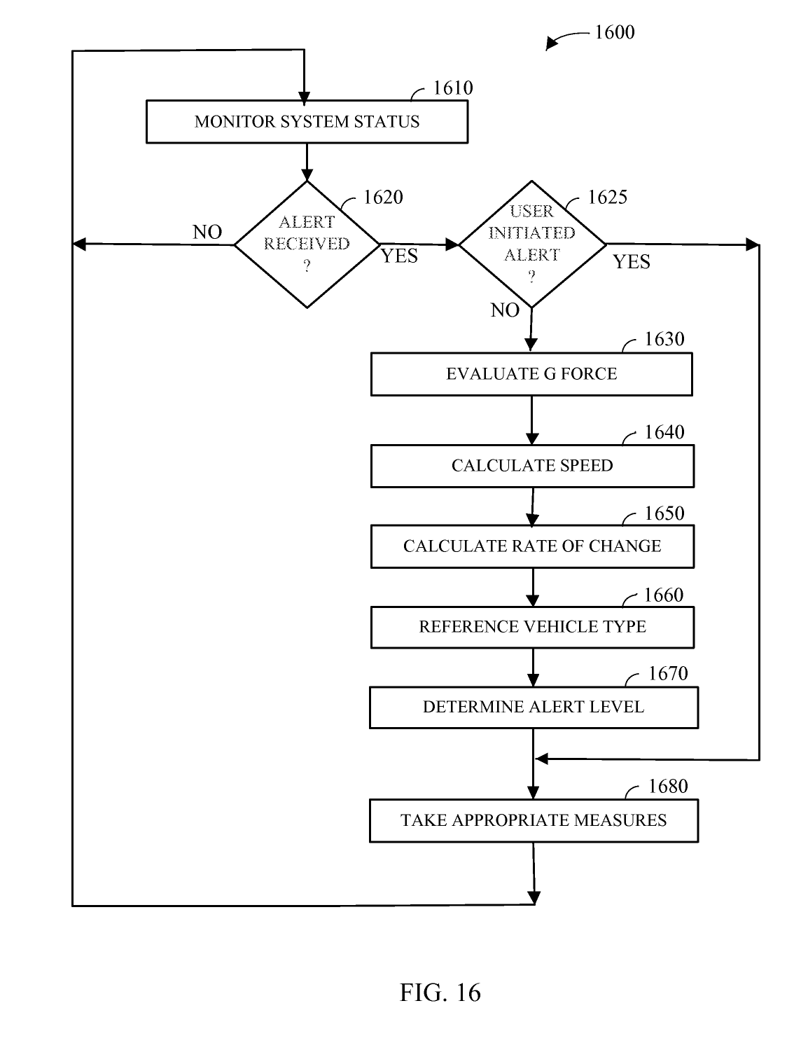

Referring now to FIG. 15, the Output Device subroutine has been initiated. The GPS subroutine is run to obtain the unit's GPS coordinates at time of output (161). The controller then assembles the latest stored GPS coordinates, tagged data, and unit info into a data packet (162). GSM signal strength is checked (163). If signal strength is good, data packet is sent to the GSM Modem for file transfer (164). If signal strength is not good or not available, the data packet is divided into smaller parts called filettes by a software (165) and sent to the Satellite Modem for file transfer (166). Unit may allow user to set default output to GSM or Satellite.

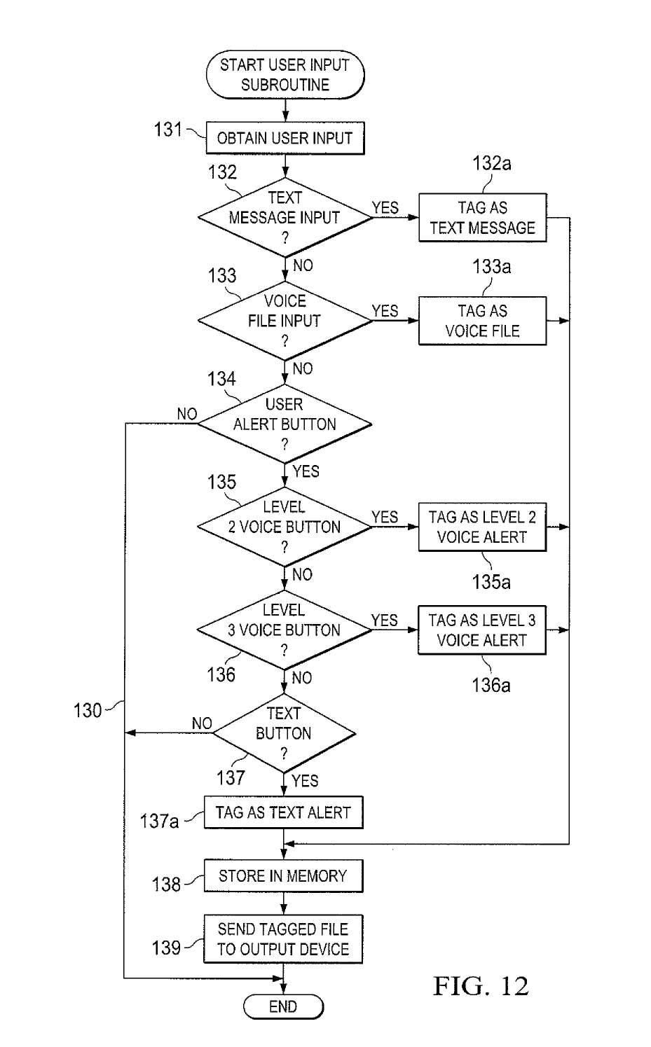

Referring now to FIG. 12, the User Input subroutine has been initiated. The controller first obtains the input data from the User Input (131). The controller then determines what kind of User input the data represents. If User Input is a text message (132), the data is tagged as text message (132a). If User Input is a voice input (133), data is tagged as voice file (133a). If User Input is from an alert button (134), type of alert button is determined, for example Level 2 Voice Button (135), Level 3 Voice Button (136), or Text Button (137) with a Level 2 Voice Button (135) tagged as a Level 2 Voice Alert (135a), a Level 3 Voice Button (136) tagged as a Level 3 Voice Alert (136a), and a Text Button (137) tagged as a Text Alert (137a). Tagged files are stored in the Memory Storage Device (138) and sent to the Output Device (139). If no alert button caused a user input, user subroutine is ended (130).

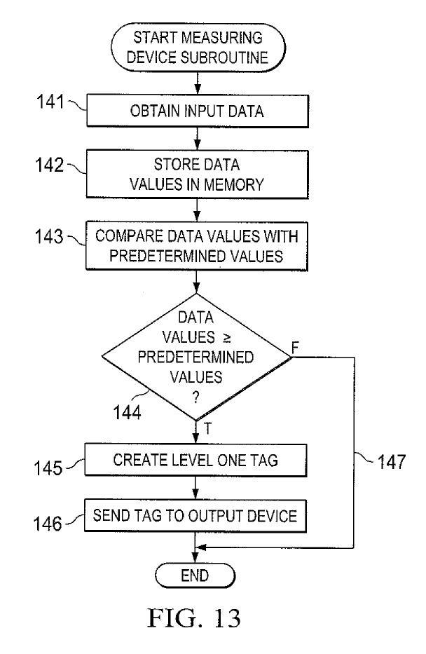

Referring now to FIG. 13, the Measuring Device subroutine has been initiated. The controller first obtains the input data from the Measuring Device (141), for example an accelerometer, and stores the data value(s) in the Memory Storage Device (142). The data value(s) are compared to predetermined value(s) set by the user or unit manufacturer (143). If the input data value(s) are greater than or equal to the pre-determined set value(s) (144), then the controller tags the data as Level 1 (145) and sends the data to the Output Device (146). If the input data value(s) is less than the predetermined set value(s), then Measuring Device subroutine is ended (147).

Referring now to FIG. 10, the GPS subroutine has been initiated. The controller (111) first obtains the input data from the GPS Module (112) and then obtains the internal current date and time. The GPS coordinates along with the date and time are stored in Memory Storage Device (113). The GPS Module obtains the GPS coordinates by communicating with a GPS satellite. The subroutine ends (114) and returns to main program.

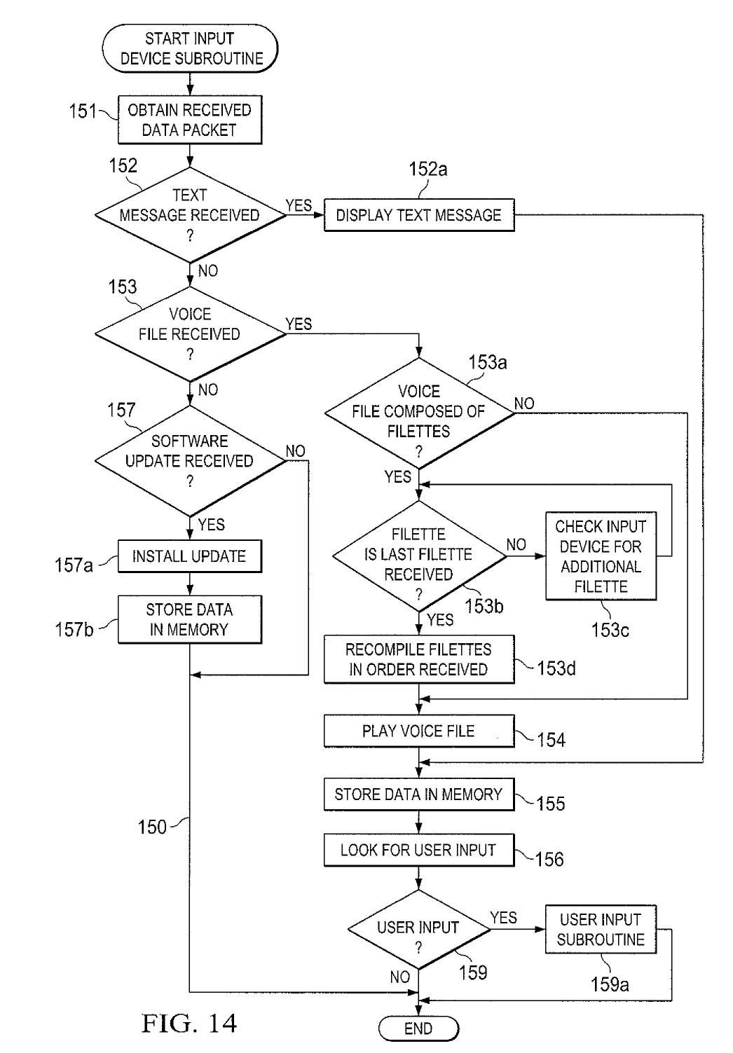

Referring now to FIG. 14, the Input Device subroutine has been initiated. The controller first obtains the data packet from the Input Device (151). If data received is a text message (152), the text message will be displayed (152a). If data received is a voice file (153), the controller will check if the voice file is composed of filettes (153a). If composed of filettes, the controller will check if filette is last filette received (153b). If not, the controller will check for more filettes received (153c) until last filette is received (153d). The filettes are then recompiled into one voice file in the order they are received (153e). The voice file is then played to the user (154). The text message or voice file is then stored in the Memory Storage Device (155) and the controller looks for any user input (156). If User Input found (159), the User Input Subroutine is initiated (159a). If no User Input is found (159), Input Device Subroutine is ended. If data received from the Input Device is neither text message nor voice file, controller checks if data received is a software update (157). If data is a software update, update is installed (157a), stored in memory (157b), and Input Device subroutine is ended (150). If data received is not a software update, Input Device subroutine is ended (150).

Referring now to FIG. 16, a flow chart is used to describe a method 1600 for implementing a response system in accordance with a preferred embodiment of the present invention. As shown in FIG. 16, a hand-held device or unit is constantly being monitored (step 1610) until an alert is received from the unit (step 1620=“YES”). When the unit is being monitored, the data related to the physical position or location of the unit as well as the speed and the G force being experienced by the unit is constantly being captured and stored by the system. As previously discussed, the GPS tracking data and the accelerometer data are used to determine location, speed, acceleration, and G force for a given unit or portable electronic device.

As long as no alert is received from the unit (step 1620=“NO”), then the system will continue to monitor the unit (step 1610). However, once an alert is received (step 1620=“YES”), then, in addition to the monitoring, an evaluation process can be initiated. In the most preferred embodiments of the present invention, an evaluation of the nature of the alert will be made (step 1625). If the alert has been user initiated (step 1625=“YES”) then the system will immediately take the appropriate measures (step 1680) based on the predetermined response for the alert provided by the user. For example, the user may have activated an alert indicating that medical was needed and, in response, medical personnel will be dispatched to the location of the unit as determined by the GPS coordinates received by the system from the unit. Other similar responses, as previously described above, may also be initiated.

However, if the alert is not user initiated (step 1625=“NO”), then the alert is most likely the result of some type of sudden or rapid change in the position, speed, acceleration, or G force experienced by the unit and, by extension, the operator of the unit. In that case, the G force will be evaluated by the system (step 1630) and the change in the rate of speed of the unit will also be reported and used to calculate the change in acceleration (positive or negative, e.g., deceleration) for the unit. By using the position and speed of the unit just prior to the alert, coupled with the position and speed of the unit just after the alert, the magnitude or rate of change in position, speed, and or acceleration (step 1650) can be used to determine the relative severity of the event that triggered the alert.

For additional granularity, the type of vehicle associated with the unit can be used to further determine the severity of the event that triggered the alert (step 1660). For example, a sudden deceleration of 15 mph for an automobile may not be a very significant change and may not necessarily indicate a dangerous condition. However, the same rate of deceleration for a bicycle or a jogger may be indicative of a catastrophic event. Similarly, a G force of 2 for a unit in an automobile may be relatively insignificant while the same level of G force for a bicycle could signal a major incident.

Once the rate of change in acceleration experienced by the unit, the amount of G force experienced by the unit, and the type of vehicle associated with the unit have all been assessed, an appropriate alert level can be determined (step 1670). Based on the alert level, the appropriate response can then be initiated (step 1680). In the most preferred embodiments of the present invention, the appropriate response will be sending an alert signal to a predetermined receiving point (e.g., sending the alert via telephone or radio message to a cell phone, emergency dispatch center, etc.) Those skilled in the art will understand and appreciate that it is not necessary to utilize all three measurements in order to determine an appropriate response, however, a more carefully tailored response can be made if all three factors are incorporated. Similarly, other factors (environmental conditions and natural phenomena, etc.) may also be used to evaluate the severity of the event and ensure that appropriate measures are initiated. For example, the time of day (e.g., day or night) as well as weather conditions, geographical terrain, proximity to or distance from a major metro area may be used to change the nature of the alert and the nature of the desired response. For example, in some cases, an ambulance may be dispatched while another combination of factors may dictate that a helicopter be dispatched instead. As previously mentioned, if the medical indicators for the user of the unit are being transmitted, other measures may also be initiated in response to the alert.

From the foregoing description, it should be appreciated that apparatus and methods for providing introduction for the purpose of enhancing cardiovascular exercise activity is provided and presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A portable communications system comprising a unit, said unit comprising:
an accelerometer; and
a satellite modem, said accelerometer commanded by a new accelerometer protocol which causes said accelerometer to automatically transmit output signals to said satellite modem, said satellite modem being communicatively coupled with a satellite communications network when said unit is subjected to a threshold level of force which activates a release of an electronic signal from said accelerometer.

2. The portable system of claim 1 wherein a plurality of output signals to be transmitted via said satellite modem can be initiated manually by a user.

3. The portable system of claim 1, wherein said unit further comprises a GSM cellular phone.

4. The portable system of claim 1, further comprising a GPS unit, said portable system being configured to provide an alert based on a first signal from said accelerometer, said first signal providing information relative to a change in speed or acceleration, said portable system being configured to provide a second signal from said GPS unit, said second signal providing information relative to a change in speed or acceleration, and wherein said alert conveys information regarding a change in status based on said first signal and said second signal.

5. The portable system of claim 4 wherein said portable system is contained within a vehicle and where said alert conveys information regarding said vehicle and a severity level for said alert is classified according to at least one characteristic of said vehicle and said change in speed or acceleration provided by said first signal and said second signal.

6. The portable system of claim 5, wherein said unit further comprises a smart phone and said first signal and said second signal and said alert are generated by a software application that has been downloaded into a memory module in said smart phone.

7. The portable system of claim 6, wherein said software application is configured to calculate a G Force experienced by said portable system based on said first signal and said second signal and wherein said alert is categorized based on said at least one characteristic of said vehicle.

8. A system for emergency response, comprising a unit capable of automatic initiation of satellite communications when it is subjected to a preset force level of 2 g or more.

9. The system of claim 8, further comprising an infrastructure which permits said unit to transmit a signal to a satellite, which then sends a signal to a monitoring center, and a monitoring center which responds or reacts to the signal pursuant to predetermined criteria.

10. The system of claim 8, providing for voice communication over a satellite data network by splitting voice files into smaller segments, transmitting from a unit over a data network via satellite to a monitoring center, wherein software at computers located at said monitoring center reassemble said voice files into a continuous voice message.

11. The system of claim 8, providing for multimedia communication over a satellite data network by splitting multimedia files into smaller segments, transmitting from a unit over a data network via satellite to a monitoring center, wherein software at computers located at said monitoring center reassemble said multimedia files into a continuous multimedia file.

12. The system of claim 8, providing for text communication over a satellite data network by splitting text files into smaller segments, transmitting from a unit over a data network via satellite to a monitoring center, wherein software at computers located at said monitoring center reassemble said text files into a continuous text message.

13. The system of claim 8, providing for automated failover from a GSM-based transmission mode to a satellite-based transmission mode by incorporating protocol changes to said unit which senses that a GSM system signal is too weak to provide an adequate communication pathway.

14. The system of claim 8, providing for manual failover from GSM-based transmission mode to a satellite-based transmission mode by incorporating protocol changes to said unit, said protocol changes being made in response to a user selecting said satellite-based transmission mode.

15. The system of claim 8, providing for bi directional text messaging over a short burst satellite network.

16. A portable hand held system for short burst satellite communication comprising GSM functionality and failover to satellite communication.

17. A method comprising the steps of:
receiving a first signal from a portable electronic device, said first signal transmitting information relative to a change in speed or acceleration for said portable electronic device;
receiving a second signal from a portable electronic device, said second signal transmitting information relative to a change in speed or acceleration for said portable electronic device;
using said first signal and said second signal to calculate a G force experienced by said portable electronic device;
determining a severity level for an alert signal based on said G force; and
transmitting said alert to a predetermined location.

18. The method of claim 17 wherein said step of determining a severity level for said alert signal comprises the steps of:
retrieving at least one data element from a data store;
identifying a type of vehicle carrying said portable electronic device based on said at least one data element retrieved from said data store; and
generating an alert signal based on said G force and said type of vehicle.

19. The method of claim 18 further comprising the step of transmitting said alert signal to a predetermined receiving point, said predetermined receiving point being extracted from said data store.

20. The method of claim 18 wherein said alert signal is further based on at least one of a plurality of additional factors, said plurality of additional factors being at least one of a time of day, a weather condition, a geographical terrain, a measured distance to a major metro area.
